(19) United States
(12) Patent Application Publication
(10) Pub. No.: US 2008/0193016 A1
(43) Pub. Date: Aug. 14, 2008

(54) Automatic Video Event Detection and Indexing

(75) Inventors: Joo Hwee Lim, Singapore (SG); Changsheng Xu, Singapore (SG); Kong Wah Wan, Singapore (SG); Qi Tian, Singapore (SG); Yu-Lin Kang, Singapore (SG)

Correspondence Address: Lipsitz & McAllister, LLC, 755 MAIN STREET, MONROE, CT, 06468, US

(73) Assignee: Agency for Science, Technology and Research, Singapore (SG)

(21) Appl. No.: 10/588,588

(22) PCT Filed: Feb. 7, 2005
(86) PCT No.: PCT/SG2005/000029

§ 371 Date: Mar. 6, 2008

Related U.S. Application Data
(60) Provisional application No. 60/542,337, filed on Feb. 6, 2004.

(51) Int. Cl. G06K 9/46

(52) U.S. Cl. 382/190

(57) ABSTRACT

A method for use in indexing video footage, the video footage comprising an image signal and a corresponding audio signal relating to the image signals, the method comprising extracting audio features from the audio signal of the video footage and visual features from the image signal of the video footage; comparing the extracted audio and visual features with predetermined audio and visual keywords; identifying the audio and visual keywords associated with the video footage based on the comparison of the extracted video and visual features with the predetermine audio and visual keywords; and determining the presence of events in the video footage based on the audio and visual keywords associated with the video footage.

### FIELD OF INVENTION

This invention relates generally to the field of video analysis and indexing, and more particularly to video event detection and indexing.

### BACKGROUND OF THE INVENTION

Current video indexing systems are yet to bridge the gap between low-level features and high-level semantics such as events. A very common and general approach relies heavily on shot-level segmentation. The steps involve segmenting a video into shots, extracting key frames from each shot, grouping them into scenes, and representing them using hierarchical tress and graphs such as scene transition graphs. However since accurate shot segmentation remains a challenging problem (analogous to object segmentation for still images), there is a mismatch between low-level information and high-level semantics.

Other video indexing systems tend to engineer the analysis process with very specific domain knowledge to achieve more accurate object or/and event recognition. The kind of highly domain-dependent approach makes the production process and resulting system very much ad-hoc and not reusable even for a similar domain (e.g. another type of sports video).

Most event detection methods in sports video are based on visual features. However, audio is also a significant part of sports video. In fact, some audio information in sports video plays an important role in semantic event detection. Compared with research done on sports video analysis using visual information, very little work has been done on sports video analysis using audio information. A speech analysis approach to detect American football touchdowns has been suggested. Actual keywords, spotting and cheering detection were applied to locate meaningful segments of video. Vision-based line-mark and goal-posts detection were used to verify the results obtained from audio analysis. Another proposed solution is to extract highlights from TV baseball programs using audio-track features alone. To deal with an extremely complex audio track, a speech endpoint detection technique in noisy environment was developed and support vector machines were applied to excited speech classification. A combination of generic sports features and baseball-specific features were used to detect the specific events.

Another proposed approach is to detect a cheering event in a basketball video game using audio features. A hybrid method was employed to incorporate both spectral and temporal features. Another proposed method to summarizes sports video using pure audio analysis. The audio amplitude was assumed to reflect the noise level exhibited by the commentator and was used as a basis for summarization. These methods tried to detect semantic events in sports video directly based on low-level features. However, in most sports videos, low-level features cannot effectively represent and infer high-level semantics.

Published US Patent Application US 2002/0018594 A1 describes a method and system for high-level structure analysis and event detection from domain-specific videos. Based on domain knowledge, low-level frame-based features are selected and extracted from a video. A label is associated with each frame according to the measured amount of the dominant feature, thus forming multiple frame-label sequences for the video.

According to Published EP Patent Application EP 1170679 A2, a given feature such as color, motion, and audio, dynamic clustering (i.e. a form of unsupervised learning) is used to label each frame. Views (e.g. global view, zoom-in view, or close-up view in a soccer video) in the video are then identified according to the frame labels, and the video is segmented into actions (play-break in soccer) according to the views. Note that a view is associated with a particular frame based on the amount of the dominant color. Label sequences as well as their time alignment relationship and transitional relations of the labels are analyzed to identify events in the video.

The labels proposed in US 2002/0018594 A1 and EP 1170679 A2 are derived from a single dominant feature of each frame through unsupervised learning, thus resulting in relatively simple and non-meaningful semantics (e.g. Red, Green, Blue for color-based labels, Medium and Fast for motion-based labels, and Noisy and Loud for audio-based labels).

Published US Patent U.S. Pat. No. 6,195,458 B1 proposes to identify within the video sequence a plurality of type-specific temporal segments using a plurality of type-specific detectors. Although type-related information and mechanism are deployed, the objective is to perform shot segmentation and not event detection.

### SUMMARY OF THE INVENTION

In accordance with a first aspect of the present invention there is provided a method for use in indexing video footage, the video footage comprising an image signal and a corresponding audio signal relating to the image signals, the method comprising extracting audio features from the audio signal of the video footage and visual features from the image signal of the video footage; comparing the extracted audio and visual features with predetermined audio and visual keywords; identifying the audio and visual keywords associated with the video footage based on the comparison of the extracted video and visual features with the predetermine audio and visual keywords; and determining the presence of events in the video footage based on the audio and visual keywords associated with the video footage. The method may further comprise partitioning the image signal and the audio signal into visual and audio sequences, respectively, prior to extracting the audio and visual features therefrom.

The audio sequences may overlap. The visual sequences may overlap.

The partitioning of visual and audio sequences may be based on shot segmentation or using a sliding window of fixed or variable lengths.

The audio and visual features may be extracted to characterize audio and visual sequences, respectively.

The extracted visual features may include one or more of measures related to motion, color, texture, shape, and outcome of region segmentation, object recognition, and text recognition.

The extracted audio features may include one or more of measures related to linear prediction coefficients (LPC), zero crossing rates (ZCR), mel-frequency cepstral coefficients (MFCC), and spectral power.

To effect the comparison, relationships between audio and visual features and audio and visual keywords may be previously established.

The relationships may be previously established via machine learning methods. The machine learning methods used to establish the relationships may be unsupervised, using preferably any one or more of: c-means clustering, fuzzy c-means clustering, mean shift, graphical models such as an expectation-maximization algorithm, and self-organizing maps.

The machine learning methods used to establish the relationships may be supervised, using preferably any one or more of: decision trees, instance-based learning, neural networks, support vector machines, and graphical models.

The determining of the presence of events in the video footage may comprise detecting video events according to a predefined set of events based on a probabilistic or fuzzy profile of the audio and video keywords.

To effect the determination, relationships between the audio and visual keyword profiles and the video events may be previously established.

The relationships between the audio and visual keyword profiles and the video events may be previously established via machine learning methods.

The machine learning methods used to establish the relationships between audio-visual keyword profiles and video events may be probabilistic-based. The machine learning methods may use graphical models.

The machine learning methods used may be techniques from syntactic pattern recognition, preferably using attribute graphs or stochastic grammars.

The extracted visual features may be compared with visual keywords and extracted audio features are compared with audio keywords independently of each other.

The extracted audio and visual features may be compared in a synchronized manner with respect to a single set of audio-visual keywords.

The method may further comprise normalizing and reconciling the outcome of the results of the comparison between the extracted features and the audio and visual keywords into a probabilistic or fuzzy profile.

The normalization of the outcome of the comparison may be probabilistic.

The normalization of the outcome of the comparison may use the soft max function.

The normalization of the outcome of the comparison may be fuzzy, preferably using the fuzzy membership function.

The outcome of the results of the comparison between the extracted features and the audio and visual keywords may be distance-based or similarity-based.

The method may further comprise transforming the outcome of determining the presence of events into a meta-data format, binary or ASCII, suitable for retrieval.

In accordance with a second aspect of the present invention there is provided a system for indexing video footage, the video footage comprising an image signal and a corresponding audio signal relating to the image signals, the system comprising means for extracting audio features from the audio signal of the video footage and visual features from the image signal of the video footage; means for comparing the extracted audio and visual features with predetermined audio and visual keywords; means for identifying the audio and visual keywords associated with the video footage based on the comparison of the extracted video and visual features with the predetermine audio and visual keywords; and means for determining the presence of events in the video footage based on the audio and visual keywords associated with the video footage.

### BRIEF DESCRIPTION OF THE DRAWINGS

FIG. 1 is a schematic diagram to illustrate key components and flow of the video event indexing method of an embodiment.

FIG. 2 depicts a three-layer processing architecture for video event detection based on audio and visual keywords according to an example embodiment.

FIGS. 3A to 3F show key frames of some visual keywords for soccer video event detection.

FIG. 4 shows a flow diagram for static visual keywords labeling in an example embodiment.

FIG. 5 is a schematic drawing illustrating break portions extraction in an example embodiment.

FIG. 6 is a schematic drawing illustrating a computer system for implementing the method and system in an example embodiment.

### DETAILED DESCRIPTION OF THE INVENTION

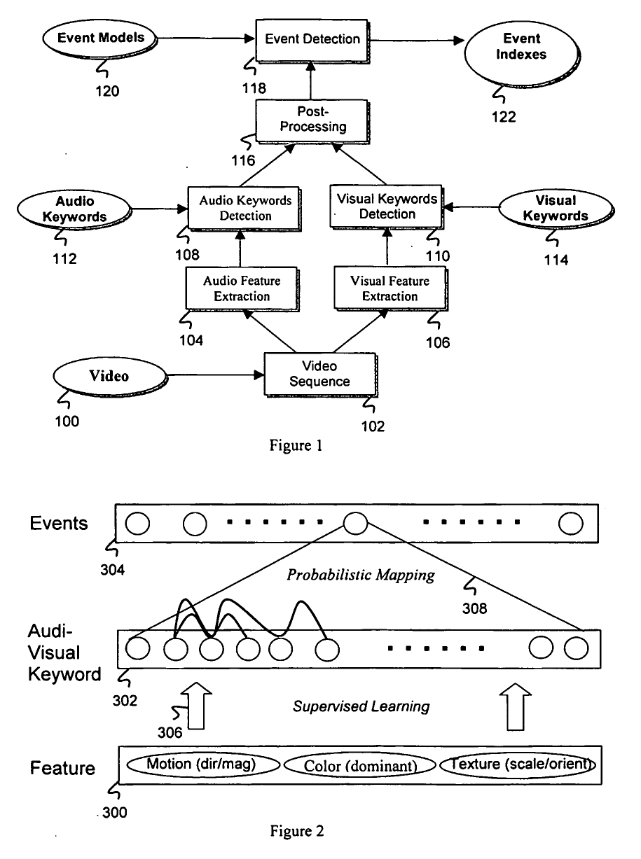

A described embodiment of the invention provides a method and system for video event indexing via intermediate video semantics referred to as audio-visual keywords. FIG. 1 illustrates key components and flow of the embodiment as a schematic diagram.

The audio and video tracks of a video 100 are first partitioned at step 102 into small segments. Each segment can be of (possibly overlapping) fixed or variable lengths. For fixed length, the audio signals and image frames are grouped by fixed window size. Typically, a window size of 100 ms to 1 sec is applied to audio track and a window size of 1 sec to 10 sec is applied to the video track. Alternatively, the system can perform audio and video (shot) segmentation. In case of audio segmentation, the system may e.g. make a cut when the magnitude of the volume is relatively low, for audio shot segmentation. For video segmentation, shot boundaries can be detected using visual cues such as color histograms, intensity profiles, motion changes, etc.

Once an audio or video tracks have been segmented at step 102, suitable audio and visual features are extracted at steps 104 and 106 respectively. For audio, features such as linear prediction coefficients (LPC), zero crossing rates (ZCR), mel-frequency cepstral coefficients (MFCC), and spectral power are extracted. For video, features related to motion vectors, colors, texture, and shape are extracted. While motion features can be used to characterize motion activities over all or some frames in the video segment, other features may be extracted from one or more key frames, for instance first, middle or last frames, or based on some visual criteria such as the presence of a specific object, etc. The visual features could also be computed upon spatial tessellation (e.g. 3×3 grids) to capture locality information. Besides low level features as just described, high-level features related to object recognition (e.g. faces, ball etc) could also be adopted.

The extracted audio and video features of the respective audio and video segments are compared at steps 108 and 110 respectively to compatible (same dimensionality and types) features of audio and visual “keywords” 112 and 114 respectively. “Keywords” as used in the description of the example embodiments and the claims refers to classifiers that represent a meaningful classification associated with one or a group of audio and visual features learned beforehand using appropriate distance or similarity measures. The audio and visual keywords in the example embodiment are consistent spatial-temporal patterns that tend to recur in a single video content or occur in different video contents where the subject matter is similar (e.g. different soccer games, baseball games, etc.) with meaningful interpretation. Examples of audio keywords include: a whistling sound by a referee in a soccer video, a pitching sound in a baseball video, the sound of a gun shooting or an explosion in a news story, the sound of insects in a science documentary, and shouting in a surveillance video etc. Similarly, visual keywords may include those such as: an attack scene near the penalty area in a soccer video, a view of scoreboard in a baseball video, a scene of a riot or exploding building in a news story, a volcano eruption scene in a documentary video, and a struggling scene in a surveillance video etc.

In the example embodiment, learning of the mapping between audio features and audio keywords and between visual features and visual keywords can be either supervised or unsupervised or both. For supervised learning, methods such as (but not limited to) decision trees, instance-based learning, neural networks, support vector machines, etc. can be deployed. If unsupervised learning is used, algorithms such as (but not limited to) c-means clustering, fuzzy c-means clustering, expectation-maximization algorithm, self-organizing maps, etc. can be considered.

The outcome of the comparison at steps 108 and 110 between audio and visual features and audio and visual keywords may require post-processing at step 116. One type of post-processing in an example embodiment involves normalizing the outcome of comparison into a probabilistic or fuzzy audio-visual keyword profile. Another form of post-processing may synchronize or reconcile independent and incompatible outcomes of the comparison that result from different window sizes used in partitioning.

The post-processed outcomes of audio-visual keyword detection serve as input to video event models 120 to perform video event detection at step 118 in the example embodiment. These outcomes profile the presence of audio-visual keywords and preserve the inevitable uncertainties that are inherent in realistic complex video data. The video event models 120 are computational models such as (but limited to) Bayesian networks, Hidden Markov models, probabilistic grammars (statistical parsing) etc as long as learning mechanisms are available to capture the mapping between the soft presence of the defined audio-visual keywords and the targeted events to be detected and indexed 122. The results of video event detection are transformed into a suitable form of meta-data, either in binary or ASCII format, for future retrieval, in the example embodiment.

An example embodiment of the invention entails the following systematic steps to build a system for video event detection and indexing:
1. The video events to be detected and indexed are defined;
2. The audio and visual keywords that are considered relevant to the spatio-temporal makeup of the events are identified.
3. The audio and visual features that are likely to be useful for the detection of the audio-visual keywords, that is those that are likely to correspond to such audio and visual keywords, are selected;
4. The mechanism to extract these audio and visual features from video data, in a compressed or uncompressed format, is determined and implemented. The mechanism also has the ability to partition the video data into appropriate segments for extracting the audio and visual features;
5. The mechanism to associate audio and visual features extracted from segmented video and the audio and visual keywords obtained from training data, based on supervised or unsupervised learning or both, is determined and implemented. The mechanism may include automatic feature selection or weighting.
6. The mechanism to map the audio and visual keywords to the video events, based on statistical or syntactical pattern recognition or both, is determined and implemented. The post-processing mechanism to normalize or synchronize the detection outcome of the audio and visual keywords is also included;
7. The training of the audio and visual keyword detection using the extracted audio and visual features is carried out and the computer representation of these audio-visual keyword detectors is saved. This is the actual machine learning step based on the learning model determined in step 5;
8. The training of video event detection using the outcome of the audio and visual detectors is carried out and the computer representation of these video event detectors is saved. This step carries out the recognition process as dictated by step 6.

The above steps in the example embodiment provide a V-shape process: top-down then bottom-up. The successful execution of the above steps results in an operational event detection system as depicted in FIG. 1, ready to perform detection and indexing of video events. A schematic diagram illustrating the processing architecture for video event detection is shown in FIG. 2, for the example embodiment. There are 3 layers: features 300, audio and visual keywords (AVK) 302, and events 304. Features extracted from video segments are fed into learned models (indicated at 306) of AVK 302 where matching of video features and model features may take place and other decision making steps. Computational models such as probabilistic mapping (indicated at 308) are then used between the AVK 302 and events 304.

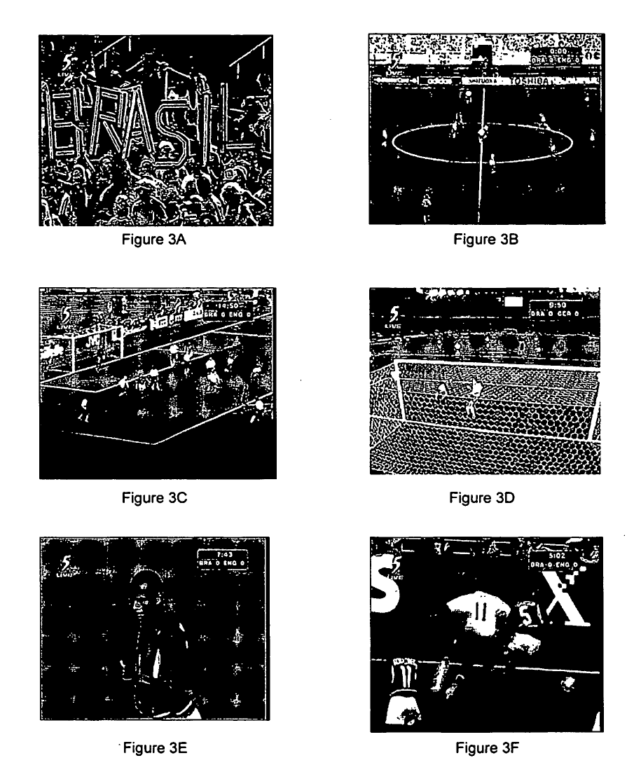

To illustrate the example embodiment further, an example processing based on a soccer video is described below with reference to FIGS. 3 to 5.

A set of visual keywords are defined for soccer videos. From the focus of the camera and the moving status of the camera point of views, the visual keywords are classified into two categories: static visual keywords (Table 1) and dynamic visual keywords (Table 2).

TABLE 1
Static visual keywords defined for soccer videos

| Keywords | Abbreviation |
|---|---|
| Far view of whole field | FW |
| Far view of half field | FH |
| Far view of audience | FA |
| View from behind the goal | GP |
| post | |
| Mid range view (whole | MW |
| body visible) | |
| Close-up view (inside field) | IF |
| Close-up view (edge field) | EF |
| Close-up view (outside | OF |
| field) | |

FIGS. 3A to 3F show the key frames of some exemplary static visual keywords, respectively: far view of audience, far view of whole field, far view of half field, view from behind the goal post, close up view (inside field), and mid range view.

Generally, “far view” indicates that the game is playing and no special event happens so the camera captures the field from far to show the whole status of the game. “Mid range view” typically indicates the potential defense and attack so that the camera captures players and ball to follow the actions closely. “Close-up view” indicates that the game might be paused due to the foul or the events like goal, corner-kick etc so that camera captures the players closely to follow their emotions and actions.

TABLE 2
Dynamic visual keywords defined for soccer videos

| Keywords | Abbreviation |
|---|---|
| Still camera | ST |
| Moving camera | MV |
| Fast moving | FM |
| camera | |

In essence, dynamic visual keywords based on motion features in the example embodiment intend to describe the camera's motion. Generally, if the game is in play, the camera always follows the ball. If the game is in break, the camera tends to capture the people in the game. Hence, if the camera moves very fast, it indicates that either the ball is moving very fast or the players are running. For example: given a “far view” video segment, if the camera is moving, it indicates that the game is playing and the camera is following the ball; if the camera is not moving, it indicates that the ball is static or moving slowly which might indicate the preparation stage before the free-kick or corner-kick in which the camera tries to capture the distribution of the players from far.

Three audio keywords are defined for the example embodiment: “Plain” (“P”), “Exciting” (“EX”) and “Very Exciting” (“VE”) for soccer videos. For a description of one technique for the extraction of the audio keywords, reference is made to Kongwah Wan and Changsheng Xu, “Efficient Multimodal Features for Automatic Soccer Highlight Generation”, in Proceedings of International Conference on Pattern Recognition (ICPR 2004), 4-Volume Set, 23-26 Aug. 2004, Cambridge, UK. IEEE Computer Society, ISBN 0-7695-2128-2, pp. 973-976, the contents of which are hereby incorporated by cross-reference.

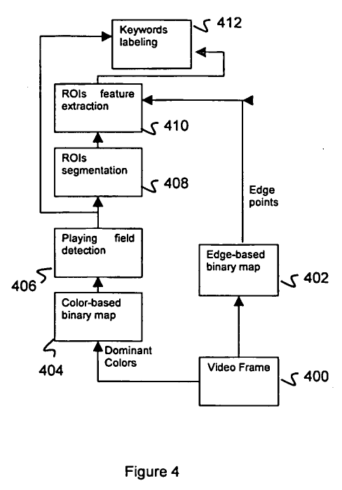

For the first step of processing in the example embodiment, conventional shot partitioning using a colour histogram approach to the video stream to segment video stream into video shots is performed. Then, shot boundaries are inserted within shots whose length is longer than 100 frames to further segment the shot into shorter segments evenly. For instance, a 150-frame shot will be further segmented into 2 video segments, 75-frame each. In the end, each video segment is labeled with one static visual keyword, one dynamic visual keyword and one audio keyword. With reference to FIG. 4, for static visual keyword classification, first all the P-Frames 400 in the video segment are converted into edge-based binary maps at step 402 by setting all the edge points into white points and other points into black points. Also, all the P-Frames 400 are converted into color-based binary maps at step 404 by mapping all the dominant color points into black points and non-dominant color points into white points. Then, the playing field area is detected at step 406 and the Regions of Interest (ROIs) within the playing field area are segmented at step 408. Finally, two support vector machine classifiers and some decision rules are applied to the position of the playing field and the properties of the ROIs such as size, position, texture ratio, etc at step 410 to label each P-Frame with one static visual keyword at step 412.

Each P-Frame 400 of the video segment is labeled with one static visual keyword in the example embodiment. Then, the static visual keyword that is labeled to the majority of P-frames is taken as the static visual keyword labeled to the whole video segment. For details of the classification of static visual keywords reference is made toYu-Lin Kang, Joo-Hwee Lim, Qi Tian, Mohan S. Kankanhalli, Chang-Sheng Xu, “Visual Keywords Labeling in Soccer Video”, in Proceedings of Int. Conf. on Pattern Recognition (ICPR 2004), 4-Volume Set, 23-26 Aug. 2004, Cambridge, UK. IEEE Computer Society, ISBN 0-7695-2128-2, pp. 850-853, the contents of which are hereby incorporated by cross-reference.

Similarly, by calculating the mean and standard deviation of the number of motion vectors within different direction regions and the average magnitude of all the motion vectors, each video segment is labeled with one dynamic visual keyword in the example embodiment.

For the audio keywords, the audio stream is segmented into audio segments of same intervals. Next, the pitch and the excitement intensity of the audio signal within each audio segment are calculated. Then, since the length of the audio segment is typically much shorter than the average length of the video segments, the video segment is used as the basic segment and the average excitement intensity of the audio segments within each video segment is calculated. In the end, each video segment is labeled with one audio keyword according to the average excitement intensity of the video segment.

In the example embodiment a statistical model is used for event detection. More precisely, Hidden Markov Models (HMM) are applied to AVK sequences in order to detect the goal event automatically. The AVK sequences that follow the goal events share similar AVK pattern. Generally, after the goal, the game will pause for a while (around 30-60 seconds). During that break period, the camera may first zooms into the players to capture their emotions and people cheer for the goal. Next, two to three slow motion replays may be presented to show the actions of the goalkeeper and shooter to the audience again. Then, the focus of the camera might go back to the field to show the exciting emotion of the players again for several seconds. In the end, the game resumes.

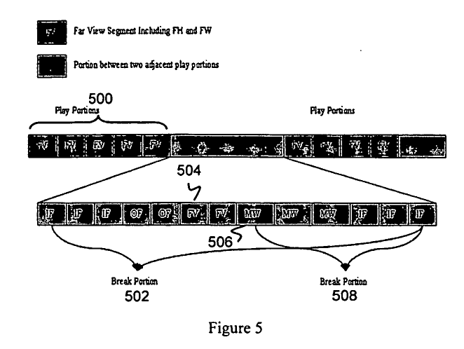

Generally, a long “far view” segment indicates that the game is in play and a short “far view” segment is sometimes used during a break. With reference to FIG. 5, play portions are extracted in the example embodiment by detecting four or more consecutive “far view” video segments e.g. 500. For break portions e.g. 502, the static visual keyword sequence is scanned from the beginning to the end sequentially. When a “far view” segment, e.g. 504 is spotted in the brake portion 502, a portion that starts from the first non-“far view” segment 506 thereafter and ending at the start of the next play portion is extracted and regarded as a break portion 508.

After break portions extraction, audio keywords are used to further extract exciting break portions. For each break portion, the number of “EX” and “VE” keywords that are labeled to the break portions are computed, denoted as EXₙᵤₘ and VEₙᵤₘ. The excitement intensity and excitement intensity ratio of this break portion is computed as:

Excitement=2×VEₙᵤₘ+EXₙᵤₘ (1)

$$Ratio = \frac{Excitement}{Length} \qquad ( 2 )$$

where Length is the number of the video segments within the break portion.

By setting thresholds for excitement intensity ratio (Tᵣₐₜᵢₒ) and excitement intensity (T_{Excitement}) respectively, the exciting break portions are extracted.

For each video segment, one static visual keyword, one dynamic visual keyword and one audio keyword are labeled in the example embodiment. Including the length of the video segment, a 13-dimensions feature vector is used to represent one video segment. Defining 12 AVKs in total, the first 12-dimensions correspond to the 12 AVKs. Given a video segment, only the dimensions that correspond to the AVKs labeled to the video segment are set to one and, other dimensions are all set to zero. The last dimension is used to describe the length of the video segment by a number between zero and one, which is the normalized version of the number of the frames of the video segment.

Hidden Markov Model is used for analyzing the sequential data in the example embodiment. Two five-state left-right HMMs are used to model the exciting break portions with goal event (goal model) and without goal event (non-goal model) respectively. Goal model likelihood is denoted with G and non-goal model likelihood with N hereafter. Observations sent to HMMs are modeled as single Gaussians in the example embodiment.

In practice, HTK is used for HMM modeling. Reference is made to S. Young, G. Evermann, D. Kershaw, G. Moore, J Odell, D. Ollason, D. Povey, V. Valtchev and P. Woodland, “The HTK book” version 3.2, CUED, Speech Group, 2002, the contents of which are hereby incorporated by cross-reference. The initial values of the parameters of the HMMs are estimated by repeatedly using Viterbi alignment to segment the training observations and then recomputing the parameters by pooling the vectors in each segment. Then, Baum-Welch algorithm is used to re-estimate the parameters of the HMMs. For each exciting break portion, we evaluate its feature vector likelihood under both two HMMs and we say the goal event is spotted within this exciting break portion if its G is bigger than its N.

Six half matches of the soccer video (270 minutes, 15 goals) from FIFA 2002 and UEFA 2002 are used in an example embodiment. The soccer videos are all in MPEG-1 format, 352×288 pixels, 25 frames/second.

AVK sequences of four half matches are labeled automatically. Since these four half matches have 9 goals only, we manually label two more AVK sequences of two half matches with 6 goals. For the purpose of cross validation, for each one of the four automatically labeled AVK sequences, the other five AVK sequences are used as training data to detect goal event from current AVK sequence.

Exciting break portions are extracted from all the six AVK sequences automatically by different sets of threshold settings. In the example embodiment, best performance was achieved when the thresholds of T_{Ratio} and T_{Excitement} are set to 0.4 and 9 respectively (Table 3).

TABLE 3
Result for goal detection (T_{Ratio} = 0.4, T_{Excitement} = 9)

| Video | Goal | Correct | Miss | False Alarm | Precision | Recall |
|---|---|---|---|---|---|---|
| GER vs | 3 | 3 | 0 | 0 | 100% | 100% |
| ENG | | | | | | |
| LEV vs LIV | 4 | 4 | 0 | 0 | 100% | 100% |
| LIV vs LEV | 1 | 1 | 0 | 0 | 100% | 100% |
| USA vs | 1 | 1 | 0 | 1 | 50% | 100% |
| GER | | | | | | |
| Total | 9 | 9 | 0 | 1 | 90% | 100% |

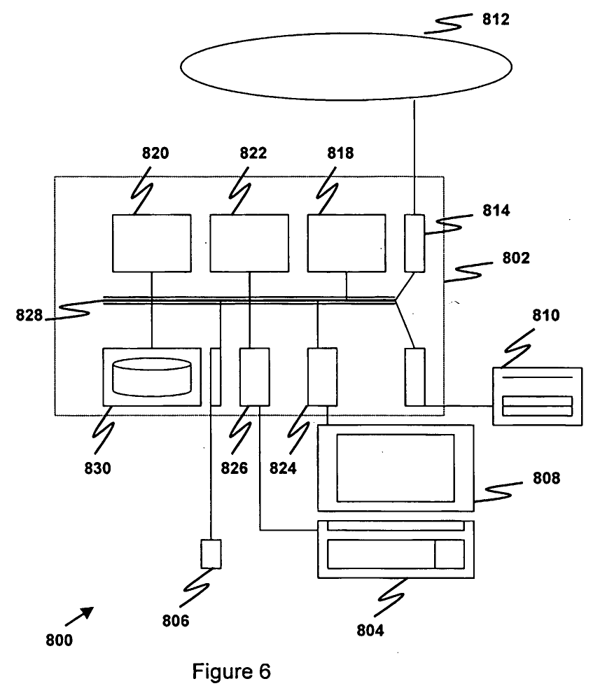

The method and system of the example embodiment can be implemented on a computer system 800, schematically shown in FIG. 6. It may be implemented as software, such as a computer program being executed within the computer system 800, and instructing the computer system 800 to conduct the method of the example embodiment.

The computer system 800 comprises a computer module 802, input modules such as a keyboard 804 and mouse 806 and a plurality of output devices such as a display 808, and printer 810.

The computer module 802 is connected to a computer network 812 via a suitable transceiver device 814, to enable access to e.g. the Internet or other network systems such as Local Area Network (LAN) or Wide Area Network (WAN).

The computer module 802 in the example includes a processor 818, a Random Access Memory (RAM) 820 and a Read Only Memory (ROM) 822. The computer module 802 also includes a number of Input/Output (I/O) interfaces, for example I/O interface 824 to the display 808, and I/O interface 826 to the keyboard 804.

The components of the computer module 802 typically communicate via an interconnected bus 828 and in a manner known to the person skilled in the relevant art.

The application program is typically supplied to the user of the computer system 800 encoded on a data storage medium such as a CD-ROM or floppy disk and read utilising a corresponding data storage medium drive of a data storage device 830. The application program is read and controlled in its execution by the processor 818. Intermediate storage of program data maybe accomplished using RAM 820.

It is noted that this example embodiment is meant to illustrate the principles described in this invention. Various adaptations and modifications of the invention made within the spirit and scope of the invention are obvious to those skilled in the art. Therefore, it is intended that the appended claims cover all such variations and modifications as come within the true spirit and scope of the invention.

1. A method for use in indexing video footage, the video footage comprising an image signal and a corresponding audio signal relating to the image signals, the method comprising:
extracting audio features from the audio signal of segments of the video footage and visual features from the image signal of the segments of the video footage, each segment comprising a plurality of frames;
comparing the extracted audio and visual features with predetermined audio and visual features associated with predetermined audio and visual keywords;
identifying the audio and visual keywords associated with the video footage based on the comparison of the extracted audio and visual features with the predetermined audio and visual features associated with the predetermined audio and visual keywords; and
determining the presence of events in the video footage based on the identified audio and visual keywords associated with the video footage.

2. A method according to claim 1, further comprising partitioning the image signal and the audio signal into visual and audio sequences, respectively, corresponding to the segments of the video footage, prior to extracting the audio and visual features therefrom.

3. A method according to claim 2, wherein the audio sequences overlap.

4. A method according to claim 2, wherein the visual sequences overlap.

5. A method according to claim 2, wherein the partitioning of visual and audio sequences is based on shot segmentation or using a sliding window of fixed or variable lengths.

6. A method according to claim 2, wherein the audio and visual features are extracted to characterize audio and visual sequences, respectively.

7. A method according to claim 1, wherein the extracted visual features include one or more of measures related to motion, color, texture, shape, and outcome of region segmentation, object recognition, and text recognition.

8. A method according to claim 1, wherein the extracted audio features include one or more of measures related to linear prediction coefficients (LPC), zero crossing rates (ZCR), mel-frequency cepstral coefficients (MFCC), and spectral power.

9. A method according to claim 1, wherein, to effect the comparison, relationships between audio and visual features and audio and visual keywords are previously established.

10. A method according to claim 9, wherein the relationships are previously established via machine learning methods.

11. A method according to claim 10, wherein the machine learning methods used to establish the relationships are unsupervised.

12. A method according to claim 10, wherein the machine learning methods used to establish the relationships are supervised.

13. A method according to claim 1, wherein determining the presence of events in the video footage comprises detecting video events according to a predefined set of events based on a probabilistic or fuzzy profile of the audio and video keywords.

14. A method according to claim 13, wherein, to effect the determination, relationships between the audio and visual keyword profiles and the video events are previously established.

15. A method according to claim 14, wherein the relationships between the audio and visual keyword profiles and the video events are previously established via machine learning methods.

16. A method according to claim 15, wherein the machine learning methods used to establish the relationships between audio-visual keyword profiles and video events are probabilistic-based.

17. A method according to claim 16, wherein the machine learning methods used graphical models.

18. A method according to claim 16, wherein the machine learning methods used are techniques from syntactic pattern recognition.

19. A method according to claim 1, wherein the extracted visual features are compared with visual keywords and extracted audio features are compared with audio keywords independently of each other.

20. A method according to claim 1, wherein extracted audio and visual features are compared with keywords in a synchronized manner with respect to a single set of audio-visual keywords.

21. A method according to claim 1, further comprising normalizing and reconciling the outcome of the results of the comparison between the extracted features and the audio and visual keywords into a probabilistic or fuzzy profile.

22. A method according to claim 21, wherein the normalization of the outcome of the comparison is probabilistic.

23. A method according to claim 22, wherein the normalization of the outcome of the comparison uses the soft max function.

24. A method according to claim 21, wherein the normalization of the outcome of the comparison is fuzzy.

25. A method according to claim 1, wherein the outcome of the results of the comparison between the extracted features and the audio and visual keywords is distance-based or similarity-based.

26. A method according to claim 1, further comprising transforming the outcome of determining the presence of events into a meta-data format, binary or ASCII, suitable for retrieval.

27. A system for indexing video footage, the video footage comprising an image signal and a corresponding audio signal relating to the image signals, the system comprising:
means for extracting audio features from the audio signal of segments of the video footage and visual features from the image signal of the segments of the video footage, each segment comprising a plurality of frames;
means for comparing the extracted audio and visual features with predetermined audio and visual features associated with predetermined audio and visual keywords
means for identifying the audio and visual keywords associated with the video footage based on the comparison of the extracted video and visual features with the predetermined audio and visual features associated with the predetermined audio and visual keywords; and
means for determining the presence of events in the video footage based on the identified audio and visual keywords associated with the video footage.
